(19) United States
(12) Patent Application Publication
(10) Pub. No.: US 2026/0004167 A1
(43) Pub. Date: Jan. 1, 2026

(54) TEXT DATA INFERENCE METHOD AND APPARATUS, STORAGE MEDIUM, AND ELECTRONIC DEVICE

(71) Applicant: Tencent Technology (Shenzhen) Company Limited, Shenzhen (CN)

(72) Inventors: Peng MENG, Shenzhen (CN); Hengfeng TIAN, Shenzhen (CN)

(73) Assignee: Tencent Technology (Shenzhen) Company Limited, Shenzhen (CN)

(21) Appl. No.: 19/322,208

(22) Filed: Sep. 8, 2025

Related U.S. Application Data
(63) Continuation of application No. PCT/CN2024/100044, filed on Jun. 19, 2024.

(30) Foreign Application Priority Data
Aug. 28, 2023 (CN) 202311085639.X

(51) Int. Cl. G06N 5/04; G06F 40/284; G06F 40/35; G06F 40/40

(52) U.S. Cl. CPC G06N 5/04; G06F 40/284; G06F 40/40; G06F 40/35

(57) ABSTRACT

The present disclosure discloses a text data inference method and apparatus, a storage medium, and an electronic device. The method includes the following operations: acquiring initial token sequences corresponding to N pieces of text data, N being an integer greater than 1, and one token in each initial token sequence characterizing one character in corresponding text data; concatenating N initial token sequences into a concatenated token sequence; and performing inference on the concatenated token sequence to obtain N reply token sequences, the N reply token sequences being configured for generating reply data of the N pieces of text data, and a starting token in each reply token sequence being obtained by: performing, in the concatenated token sequence, inference on tokens belonging to the same initial token sequence.

### RELATED APPLICATION

This application is a continuation of and claims the benefit of priority to PCT Application No. PCT/CN2024/100044, filed Jun. 19, 2024, and entitled TEXT DATA REASONING METHOD AND APPARATUS, STORAGE MEDIUM AND ELECTRONIC DEVICE, which is based on and claims the benefit of priority to Chinese Patent Application No. 202311085639.X, entitled “TEXT DATA INFERENCE METHOD AND APPARATUS, STORAGE MEDIUM, AND ELECTRONIC DEVICE” and filed with the China National Intellectual Property Administration on Aug. 28, 2023. The above applications are incorporated herein by reference in their entireties.

### FIELD OF THE TECHNOLOGY

This application relates to the technical field of computers, and in particular, to a text data inference technology.

### BACKGROUND OF THE DISCLOSURE

With the rapid development of advanced technologies, a large language model (LLM) with a strong inference capability has emerged. For example, based on the inference capability of the LLM, the computer device may invoke a large number of model parameters in the LLM to perform inference on “Next line of “I find the face of east wind in an easy way”” to obtain an inference result of “Myriads of reds and violets only reveal spring”.

In the foregoing inference process, the actual number of model parameters required to be invoked by the computer device reaches hundreds of billions. For example, in an inference process of a generative pre-trained transformer 3 (GPT3) model, the number of involved model parameters reaches 175 billion (175B). As a result, the computer device needs to consume a large number of graphics processing unit (GPU) resources in the data inference process.

In the related art, to avoid low GPU resource utilization efficiency caused by performing inference on only one piece of text data each time, a manner of performing data inference using a plurality of pieces of text data as the same batch is proposed. Further, to adapt the inference process to the existing deep learning model framework, a character supplementation manner is further proposed, that is, padding characters are supplemented to relatively short text data, so that the lengths of the plurality of pieces of text data processed in the same batch keep consistent.

However, the padding characters added in the foregoing character supplementation manner will also participate in an actual inference operation, which will cause a large number of invalid calculations and consumption of a large number of invalid GPU resources.

### SUMMARY

The present disclosure provides a multi-text data inference method and apparatus, a storage medium, and an electronic device, to reduce GPU resources consumed by the inference of a plurality of pieces of text data and improve the inference performance of a computer device on the plurality of pieces of text data.

According to a first aspect, the present disclosure provides a text data inference method. The method is performed by a computer device and includes the following operations:
acquiring initial token sequences corresponding to N pieces of text data, N being an integer greater than 1, and one token in each initial token sequence characterizing one character in corresponding text data;
concatenating N initial token sequences into a concatenated token sequence, the concatenated token sequence being a token sequence including tokens in the N initial token sequences; and
performing inference on the concatenated token sequence to obtain N reply token sequences, the N reply token sequences being configured for generating reply data of the N pieces of text data, and a starting token in each reply token sequence being obtained by: performing, in the concatenated token sequence, inference on tokens belonging to the same initial token sequence.

According to a second aspect, the present disclosure provides a text data inference apparatus. The apparatus is deployed on a computer device and includes:
an acquisition unit configured to acquire initial token sequences corresponding to N pieces of text data, N being an integer greater than 1, and one token in each initial token sequence characterizing one character in corresponding text data;
a concatenation unit configured to concatenate N initial token sequences into a concatenated token sequence, the concatenated token sequence being a token sequence including tokens in the N initial token sequences; and
an inference unit configured to perform inference on the concatenated token sequence to obtain N reply token sequences, the N reply token sequences being configured for generating reply data of the N pieces of text data, and a starting token in each reply token sequence being obtained by: performing, in the concatenated token sequence, inference on tokens belonging to the same initial token sequence.

According to a third aspect, the present disclosure provides a computer device, including a memory, a processor, and a computer program stored on the memory and executable on the processor, the processor, when executing the computer program, implementing any text data inference method in the first aspect.

According to a fourth aspect, the present disclosure provides a computer storage medium, having a computer program stored therein, the computer program, when executed by a processor, implementing any text data inference method in the first aspect.

According to a fifth aspect, an embodiment of the present disclosure provides a computer program product, including a computer program, the computer program, when executed by a processor, implementing any text data inference method in the first aspect.

Beneficial effects of the present disclosure are as follows.

In the embodiments of the present disclosure, a text data inference method is proposed. The method is an optimized concatenating manner of a plurality of pieces of text data. Specifically, the computer device acquires the initial token sequences corresponding to the N (N being an integer greater than 1) pieces of text data. One token in each acquired initial token sequence characterizes one character in the corresponding text data. Then, the computer device concatenates the N initial token sequences into the concatenated token sequence. The concatenated token sequence is a token sequence including the tokens in the N initial token sequences, that is, the concatenated token sequence contains all tokens in the N initial token sequences, thereby concatenating the N initial token sequences into one token sequence and realizing redundancy-free concatenating for the N initial token sequences. Then, inference is performed on the concatenated token sequence to obtain the N reply token sequences. The N reply token sequences herein are configured for generating the reply data of the N pieces of text data, and the starting token in each reply token sequence is obtained by: performing, in the concatenated token sequence, inference on tokens belonging to the same initial token sequence. Inference is performed based on the concatenated token sequence so that multi-text data inference without supplementation of padding characters may be implemented. Compared with the character supplementation manner provided in the related art, since there is no need to supplement the padding characters, redundant GPU resources do not need to be consumed for the padding characters, thereby reducing GPU resources consumed by the inference of the plurality of pieces of text data, reducing an inference cost of the text data, and improving the inference performance of the computer device on the plurality of pieces of text data.

Other features and advantages of the present disclosure will be described in the following specification, and in part will become apparent from the specification or may be learned from the implementation of the present disclosure. The objectives and other advantages of the present disclosure may be implemented and obtained through structures particularly pointed out in the written specification, claims, and accompanying drawings.

### BRIEF DESCRIPTION OF THE DRAWINGS

The accompanying drawings described herein are used for providing a further understanding of the present disclosure, and form a part of the present disclosure. Exemplary embodiments of the present disclosure and descriptions thereof are used for explaining the present disclosure, and do not constitute any inappropriate limitation to the present disclosure. In the drawings:

FIG. 1 is an example schematic diagram of an exemplary application scene according to an embodiment of the present disclosure.

FIG. 2 is an example schematic flowchart of a text data inference method according to an embodiment of the present disclosure.

FIG. 3A to FIG. 3B are example schematic diagrams of a possible dialog scene according to an embodiment of the present disclosure.

FIG. 4 is an example schematic diagram of an inference process based on a deep learning model framework according to an embodiment of the present disclosure.

FIG. 5 is an example schematic diagram of supplementation of N initial token sequences according to an embodiment of the present disclosure.

FIG. 6A to FIG. 6D are example schematic diagrams of a process of acquiring a concatenated token sequence according to an embodiment of the present disclosure.

FIG. 7 is an example schematic diagram of a process of performing inference on a concatenated token sequence based on a deep learning model framework according to an embodiment of the present disclosure.

FIG. 8A to FIG. 8B are example schematic diagrams of a possible attention matrix according to an embodiment of the present disclosure.

FIG. 9 is an example schematic diagram of a text data inference apparatus according to an embodiment of the present disclosure.

FIG. 10 is an example schematic structural diagram of a computer device according to an embodiment of the present disclosure.

### DESCRIPTION OF EMBODIMENTS

To make the objectives, technical solutions, and advantages of embodiments of the present disclosure clearer, the technical solutions in the embodiments of the present disclosure will be clearly and completely described below in conjunction with the accompanying drawings in the embodiments of the present disclosure.

In the embodiments of the present disclosure, processing such as acquisition, storage, usage, processing, transmission, providing, and disclosure of user's personal information involved all comply with the provisions of relevant laws and regulations and does not violate the public order and good custom.

The embodiments of the present disclosure relate to artificial intelligence (AI) technology, and mainly relate to nature language processing (NLP) technology in the AI technology.

AI: it involves a theory, a method, a technology, and an application system that use a digital computer or a machine controlled by the digital computer to simulate, extend, and expand human intelligence, perceive an environment, acquire knowledge, and use knowledge to obtain an optimal result.

The AI technology is a comprehensive discipline and relates to a wide range of fields including hardware-level technologies and software-level technologies. A pre-trained model is alternatively referred to as a large model or a basic model, and after fine tuning, may be widely applied to various downstream AI tasks. Basic AI technologies generally include technologies such as a sensor, a dedicated AI chip, cloud computing, distributed storage, a big data processing technology, an operating/interaction system, and electromechanical integration. AI software technologies mainly include several major directions such as a computer vision (CV) technology, a speech processing technology, an NLP technology, machine learning/deep learning, automatic driving, and intelligent transportation.

NLP: it is an important direction in the fields of computer science and AI. It studies various theories and methods that can realize effective communication between humans and computers using nature languages. NLP involves natural languages, e.g., languages daily used by people, and is closely related to the study of linguistics. Meanwhile, computer science and mathematics are involved. An important technology of model training in the field of AI, i.e., a pre-trained model, is developed from the LLM in the field of NLP. After fine tuning, the LLM may be widely applied to downstream tasks. The NLP technology generally includes technologies, such as text processing, semantic understanding, machine translation, robot question-answering, and knowledge graphs. The pre-trained model is the latest development result of deep learning and combines the foregoing technologies.

The embodiments of the present disclosure further relate to machine learning. A text inference model configured for inference may be obtained through training by machine learning.

With the research and progress of the AI technology, the AI technology has been researched and applied to a plurality of fields, such as common smart home, smart wearable devices, virtual assistants, smart speakers, intelligent marketing, unmanned driving, autonomous driving, unmanned aerial vehicles, digital twins, virtual humans, robots, artificial intelligence generated content (AIGC), conversational interaction, intelligent medical, intelligent customer service, and game AI. With the development of the technology, the AI technology will be applied to more fields, and plays an increasingly important role.

In the embodiments of the present disclosure, the AI technology is applied to the field of data inference to reduce GPU resources consumed by the inference of a plurality of pieces of text data based on the text inference model (for example, the pre-trained model) and improve the inference performance of the computer device on the plurality of pieces of text data.

To facilitate understanding of the technical solutions provided in embodiments of the present disclosure, some key terms used in the embodiments of the present disclosure are explained below.

Pre-trained model: it refers to a model obtained by performing training on a large-scale corpus, and an unsupervised learning method is usually used, for example, an autoencoder and a language model. A basic idea of the pre-trained model is to make the model learn a large amount of general knowledge and rules using the large-scale corpus through an unsupervised learning method, thereby serving as a basic model of various NLP tasks. For example, in the embodiments of the present disclosure, based on the pre-trained model, adaptive training adaptive to a recommendation reason generation task is added so that an obtained model can be configured for recommendation reason generation.

As an example, the text inference model involved in the embodiments of the present disclosure is a pre-trained model, and may be specifically any deep learning model, for example, a generative pre-trained transform (GPT) (chat generative pre-trained transformer (ChatGPT)) model or a pre-trained language model (PLM) (bidirectional encoder representations from transformers (BERT)).

Transformer: it is a common deep learning model architecture and is widely applied to various fields such as NLP, CV, and speech processing. When originally proposed, the transformer is a sequence-to-sequence model architecture configured for machine translation, and includes an encoder and a decoder. The encoder and the decoder each include a series of transformer blocks with the same structure. Each transformer block includes at least a multi-head self-attention layer and a feedforward neural network layer. Currently, the transformer has become a common architecture in the NLP and is usually used as a pre-trained model. In addition to language-related application, the transformer is further applied to fields such as CV and audio processing.

Language model: it is a model configured for modeling a nature language, and an objective of the model is to predict a next word or character of a given text sequence. The language model may be applied to multiple NLP tasks, such as semantic extraction of text, text generation, machine translation, and speech recognition. Currently, a transformer-based PLM is relatively common on various tasks of NLP and can usually achieve good effects. For example, common PLMs include a BERT model, a GPT model, and the like.

LLM: it refers to an NLP model with a large-scale parameters and training data. A training process of the LLM usually adopts an unsupervised learning manner, that is, the model is trained through a large-scale text corpus to learn the language probability distribution and language rules. In the training process, the LLM usually uses a language model as a target function, that is, a model parameter is optimized by maximizing a prediction probability of a next word. For example, GPT series models based on the transformer model structure are trained on a large-scale corpus, and may generate high-quality nature language texts, such as articles and dialogs.

Tokenizer: it is a tool that converts a nature language text into a character, word, or sub-token sequence. In the transformer model, the tokenizer usually refers to a tool that converts a nature language text into a token sequence required by the model input. Usually, a token method based on a word or a sub-token is adopted, for example, byte pair encoding (BPE) or sentence piece. According to these methods, a word or a sub-token may be split into smaller units so that the model may better process an uncommon word or a word that does not exist in a vocabulary.

Attention mechanism: it is a manner of measuring intermediate features of a network using advanced information to cause the network to focus on the part of the information in the image that assists determination, and ignore irrelevant information. The essence of the attention mechanism comes from the human visual attention mechanism. Generally, when perceiving a thing through vision, people do not view the whole thing from beginning to end every time, but often observe and pay attention to a specific part according to requirements. In addition, when people find that a thing they want to observe often appears in a specific part of a scene, they learn to pay attention to the part when a similar scene appears in the future. Therefore, the attention mechanism is essentially a means for screening high-value information from a large amount of information. In the large amount of information, different information has different importance to the result, and the importance may be reflected by assigning weights of different values. In other words, the attention mechanism may be understood as a rule of distributing weights when a plurality of sources are combined. Generally, it may be configured for resolving a problem that it is difficult to obtain a final proper vector representation when an input sequence of a model is relatively long. An intermediate result of the model is retained, the new model is adopted to learn the intermediate result, and the new model is associated with an output to screen the information. The attention mechanism includes an attention mechanism, a self-attention mechanism, a single-head attention mechanism, a multi-head attention mechanism, and the like.

Token: it is a minimum semantic unit obtained after text data is processed and is alternatively referred to as tokenization. The token is a basic element in the text data and may be a word, a phrase, a punctuation, a sub-token, or a character. This specifically depends on a requirement and context of the NLP task.

A design idea of the embodiments of the present disclosure is briefly described below.

Currently, a dialog-type LLM usually adopts a deep learning model architecture such as the transformer. In addition, the number of model parameters of the existing LLM reaches more than 7 billion, for example, model parameters of GPT3 are as high as 17.5 billion. Consequently, a model inference process consumes a huge amount of GPU resources.

For the foregoing problem, to avoid low GPU resource utilization efficiency caused by performing inference on only one piece of text data each time, a manner of performing data inference using a plurality of pieces of text data as the same batch is proposed. Relevant technical solutions may be summarized into the following two types.

First relevant solution: Before data inference is performed using a plurality of pieces of text data as the same batch, to ensure that the inference process can adapt to the existing deep learning framework, padding characters need to be supplemented to relatively short text data so that the lengths of the plurality of pieces of text data processed in the same batch keep consistent.

However, the padding characters added in the foregoing character supplementation manner will also participate in an actual inference operation, which will cause a large number of invalid calculations and consumption of a large number of invalid GPU resources. Further, even if at least two pieces of text data with a consistent length are selected from the plurality of pieces of text data as processing objects of the same batch, supplementation of the padding characters cannot be completely avoided. In addition, only in a scene where there are enough pieces of text data, two pieces of text data with a consistent length may be found. In other words, this manner is limited by a data volume of the plurality of pieces of text data and the length distribution of the plurality of pieces of text data, causing a large number of invalid calculations and consumption of a large number of invalid GPU resources.

Second relevant solution: Based on the first relevant solution, a model framework of the LLM is improved, and then redundant padding characters involved in the first relevant solution are filtered based on the improved model framework to resolve invalid calculations and invalid GPU resource consumption caused by the redundant padding characters.

However, according to the foregoing manner of improving the model framework, first, modification needs to be performed at the model framework level, which is only suitable for specific model frameworks. Secondly, there are limitations at a model application level. As for the current application, only Bert-type text understanding applications are supported, but not dialog-type or generative LLM applications.

In view of this, the embodiments of the present disclosure provide a text data inference method. In an inference scene applicable to various LLM applications, the method may greatly improve the inference performance of a computer device for a plurality of pieces of text data by invoking a large number of model parameters. For example, for N pieces of text data with large differences in length, this solution, compared with the character supplementation manner provided in the related art, can improve the inference performance by more than doubling. This solution can not only adapt to the existing deep learning model framework, but also realize model framework independence to adapt to a model framework proposed later, improve the utilization of GPU resources, and reduce the inference cost of the text data.

Specifically, in the embodiments of the present disclosure, an optimized concatenating manner of a plurality of pieces of text data is provided. Initial token sequences corresponding to the acquired N pieces of text data are concatenated to obtain a concatenated token sequence. The concatenated token sequence contains all tokens in the N initial token sequences. In this way, compared with the character supplementation manner provided in the related art, since there is no need to supplement the padding characters, redundant GPU resources do not need to be consumed for the padding characters so that GPU resources required for subsequent inference can be effectively saved, thereby reducing the inference cost of the text data.

Application scenes to which the technical solutions of the embodiments of the present disclosure can be applied are briefly introduced below. The application scenes described below are merely used for describing the embodiments of the present disclosure but are not intended to limit the embodiments. In a specific implementation process, the technical solutions provided in the embodiments of the present disclosure may be flexibly applied according to actual needs.

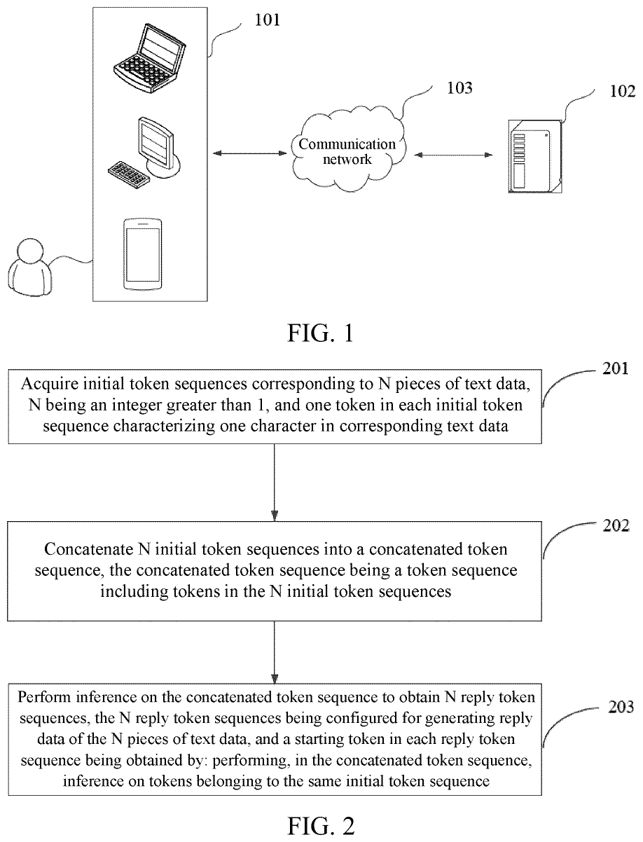

The solutions provided in the embodiments of the present disclosure may be applicable to a text data inference scene to reduce GPU resources consumed by the inference of a plurality of pieces of text data and improve the inference performance of the computer device on the plurality of pieces of text data. FIG. 1 is a schematic diagram of an application scene according to an embodiment of the present disclosure. In this scene, a terminal device 101 and a server 102 may be included.

For example, the terminal device 101 may be any device related to text data inference, such as a mobile phone, a tablet computer (PAD), a notebook computer, a desktop computer, a smart television, an intelligent in-vehicle device, an intelligent wearable device, or an aircraft. A target application may be installed on the terminal device 101. The target application may have functions such as acquiring N pieces of to-be-inferred text data inputted by a user object, presenting the N pieces of text data, acquiring initial token sequences corresponding to the N pieces of text data, concatenating N initial token sequences into a concatenated token sequence, acquiring the concatenated token sequence, acquiring and presenting reply token sequences of the N pieces of text data, and acquiring and presenting reply data of the N pieces of text data. The target application may be, for example, an instant messaging application, a music application, a game application, a video application, a short video application, a news application, or a shopping application. The application involved in this embodiment of the present disclosure may be a software client, or may be a client such as a web page or a mini program. The server 102 is a server corresponding to the software, web page, mini program, or the like. A specific type of the client is not limited.

The foregoing terminal device 101 does not need to acquire the initial token sequences corresponding to the N pieces of text data, concatenate the N initial token sequences into the concatenated token sequence, and acquire the concatenated token sequence. Alternatively, after the terminal device 101 transmits the N pieces of text data to the server 102, the concatenated token sequence is generated by the server 102 through processing based on the N pieces of received text data.

The server 102 may be a backend server of the target application and is configured to provide a corresponding backend service for the target application, for example, a data inference service. The server 102 may be an independent physical server, may be a server cluster or a distributed system including a plurality of physical servers, or may be a cloud server that provides basic cloud computing services such as a cloud service, a cloud database, cloud computing, a cloud function, cloud storage, a network service, cloud communication, a middleware service, a domain name service, a security service, a content delivery network (CDN), and a big data and AI platform, but is not limited thereto.

The text data inference method in the embodiments of the present disclosure may be separately performed by the terminal device 101 or the server 102, or may be jointly performed by the server 102 and the terminal device 101. When the method is separately performed by the terminal device 101 or the server 102, a process of performing data inference using the application model may be separately implemented by the terminal device 101 or the server 102. For example, on the terminal device 101, initial token sequences corresponding to N pieces of to-be-processed text data (N being an integer greater than 1) may be concatenated to obtain a concatenated token sequence, and then inference is performed on the concatenated token sequence based on an attention mechanism to obtain N reply token sequences. Alternatively, the server 102 may perform one or a combination of the foregoing token processing process, concatenating process, and inference process. When the method is jointly performed by the server 102 and the terminal device 101, after training the LLM, the server 102 may deploy a pre-trained language model to the terminal device 101, and the terminal device 101 implements a data inference process. Alternatively, some data inference processes may be implemented by the server 102, and other processes may be implemented by the terminal device 101. During actual application, specific configuration may be performed according to the situation. This is not specifically limited in the present disclosure.

The server 102 and the terminal device 101 may each include one or more processors, a memory, an interactive input/output (I/O) interface, and the like. In addition, the server 102 may further be configured with a database, which may be configured to store model parameters obtained through training, trained text inference models, and the like. The memory of the server 102 and the memory of the terminal device 101 may further store program instructions that need to be executed in the text data inference method provided in the embodiments of the present disclosure. When executed by the processor, the program instructions can be configured for implementing the data inference process provided in the embodiments of the present disclosure.

When the text data inference method provided in the embodiments of the present disclosure is separately performed by the server 102 or the terminal device 101, the foregoing application scene may contain only the server 102 or the terminal device 101, or the server 102 and the terminal device 101 may be considered as the same device. Certainly, in actual application, when the text data inference method provided in the embodiments of the present disclosure is jointly performed by the server 102 and the terminal device 101, the server 102 and the terminal device 101 may be the same device. That is, the server 102 and the terminal device 101 may be different functional modules of the same device, or may be virtual devices virtualized by the same physical device.

In the embodiments of the present disclosure, the terminal device 101 and the server 102 may be in direct or indirect communication connection through one or more networks 103. The network 103 may be a wired network or a wireless network. For example, the wireless network may be a mobile cellular network, may be a wireless-fidelity (WIFI) network, or certainly may be another possible network. This is not limited in the embodiments of the present disclosure. FIG. 1 is merely an example for description. Actually, the number of terminal devices and servers is not limited and is not specifically defined in this embodiment of the present disclosure.

The method provided in the exemplary implementations of the present disclosure is described below with reference to the foregoing described application scene and the accompanying drawings. The foregoing application scene is merely shown for ease of understanding the spirit and principle of the present disclosure, and the implementations of the present disclosure are not limited in this aspect. In addition, the following method may be performed by the terminal device or the server, or may be jointly performed by the terminal device and the server. Here, the method being performed by the terminal device or the server is specifically shown as an example.

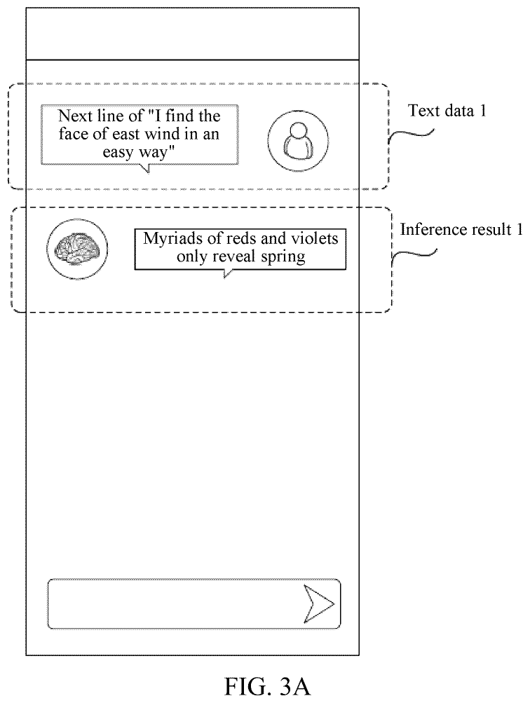

FIG. 2 is an implementation flowchart of a text data inference method according to an embodiment of the present disclosure. An example in which a computer device characterizing a terminal device or a server is an execution subject is used. A specific implementation process of the method is as follows.

Operation 201: Acquire initial token sequences corresponding to N pieces of text data, N being an integer greater than 1, and one token in each initial token sequence characterizing one character in corresponding text data.

In this embodiment of the present disclosure, the text data may be data in a text form and needs to be replied to. One piece of text data may be one dialog request triggered by a user object, and the N pieces of text data may be N dialog requests triggered by the same (or different) user object. The computer device, in response to receiving the N dialog requests, uses the N pieces of corresponding text data as model inputs of a text inference model (for example, the LLM) and invokes a large number of model parameters in the text inference model to perform inference on the N pieces of text data.

Specifically, using a dialog application scene as an example, only after the user object inputs the N pieces of text data on a front-end interface of the computer device, the computer device processes the N pieces of text data. Alternatively, after the user object inputs M (M being an integer greater than N) pieces of text data on the front-end interface of the computer device, the computer device extracts N pieces of text data for processing.

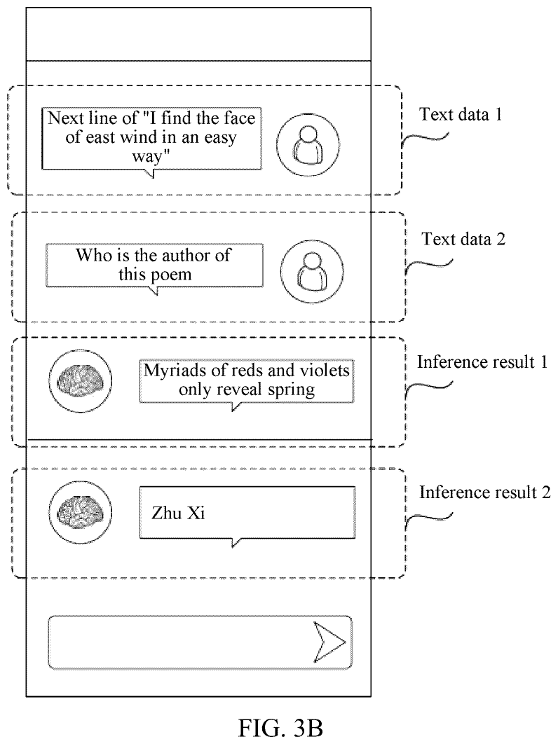

FIG. 3A is a schematic diagram of a dialog scene. The user object inputs “Next line of “I find the face of east wind in an easy way”” on the front-end interface. In the related art, after receiving the text data, i.e., receiving a dialog request or a model input, the computer device invokes a large number of model parameters in the text inference model to perform inference on “Next line of “I find the face of east wind in an easy way”” to obtain an inference result of “Myriads of reds and violets only reveal spring”.

However, for the manner shown in FIG. 3A, each time the computer device receives one piece of text data, a large number of model parameters in the text inference model need to be invoked, thereby consuming a large number of GPU resources. To resolve the problem, in the embodiments of the present disclosure, only after two or more pieces of text data are received, is the text data processed. The following describes a dialog scene to which the technical solutions provided in the embodiments of the present disclosure are applicable.

FIG. 3B is a schematic diagram of another dialog scene. The user object inputs “Next line of “I find the face of east wind in an easy way”” on the front-end interface. After receiving the text data, i.e., receiving a dialog request or a model input, the computer device will not immediately invoke a large number of model parameters in the text inference model. Instead, after receiving N pieces of text data, the computer device invokes a large number of model parameters in the text inference model to obtain corresponding inference results. An example in which two pieces of text data are received is used herein. That is, the user object inputs “Who is the author of this poem” again. Then, after receiving two dialog requests or two model inputs, the computer device invokes a large number of model parameters in the text inference model to obtain an inference result 2 “Myriads of reds and violets only reveal spring” corresponding to text data 1 and an inference result 2 “Zhu Xi” corresponding to text data 2. In this way, in an actual application process, facing a large amount of text data, a manner of processing a plurality of pieces of text data in this solution may improve the utilization of the GPU, compared with a manner of processing a single piece of text data one by one.

The initial token sequence may be a sequence obtained by encoding characters of the text data and arranging tokens corresponding to the characters according to a character sequence. In actual application, a manner of acquiring the initial token sequences corresponding to the N pieces of text data may be acquiring N pieces of to-be-replied text data and then performing the following operation on the N pieces of obtained text data: encoding, for each piece of text data, characters in the text data into corresponding tokens to obtain an initial token sequence corresponding to the text data.

Specifically, using one piece of text data as an example, one piece of text data may be segmented into a plurality of characters through a tokenizer to obtain a corresponding character sequence, and then the characters are encoded, with one encoded character being considered as one token, to obtain a corresponding initial token sequence.

One token is a minimum semantic unit. In this embodiment of the present disclosure, the character is mainly used as an example for description. For example, characters in “Next line of “I find the face of east wind in an easy way”” may be divided into “Next-line-of-“I-find-the-face-of-east-wind-in-an-easy-way””.

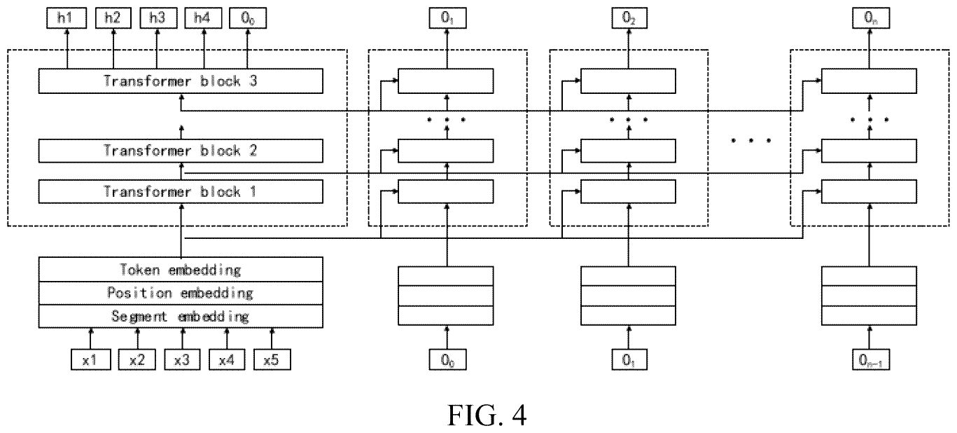

In this embodiment of the present disclosure, the text data is tokenized so that vocabulary, syntax, and semantic information in the text data may be captured, thereby being better configured for subsequent inference tasks. In a more specific example, FIG. 4 is a schematic diagram of an inference process based on a deep learning model framework. X1, X2, X3, X4, and X5 represent model inputs. A dialog-type LLM (for example, ChatGPT) is used as an example. X1, X2, X3, X4, and X5 may represent: tokens in an initial token sequence obtained after characters in a piece of text data inputted by the user object are encoded; h1, h2, h3, h4, O0 represent: corresponding outputs of tokens in an initial token sequence after being calculated by the LLM (i.e., inference tokens), where h1, h2, h3, and h4 are omitted. Then, O0 represents a first inference token in inference results generated by the model. O0 is inputted into the model to continue calculation to generate a next inference token. Each time an inference token is generated, all model parameters in the LLM participate in the calculation. Herein, an LLM with 10 billion parameters is used as an example. It is assumed that the model is stored in half-precision (FP16), with a size of 20 GB. Each time an inference token is generated, the LLM of 20 GB needs to be loaded from a video memory and participates in the calculation. Therefore, video memory bandwidth becomes a main bottleneck in the LLM-based text data inference process.

In the related art, to improve the utilization of the GPU, a plurality of pieces of text data are generally concatenated together. In this way, the model is loaded once to generate inference results of the plurality of pieces of text data, thereby alleviating the bottleneck of video memory bandwidth in the model inference process.

However, in actual application, lengths of the initial token sequences corresponding to the N pieces of acquired text data are different, that is, the numbers of tokens included in the N initial token sequences are different. For matching, various GPU calculation acceleration libraries (for example, CuBLAS) are used. In the related art, before the model is invoked, the N initial token sequences need to be supplemented to the same length using padding characters.

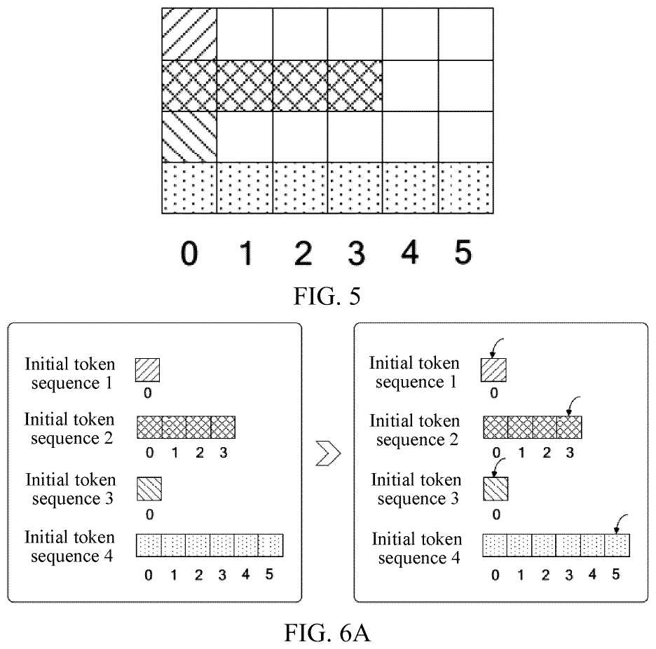

FIG. 5 is a schematic diagram of supplementation of N initial token sequences in the related art according to an embodiment of the present disclosure. A row represents: an initial token sequence. A non-blank square represents: a token. A blank square represents: a token corresponding to a padding character configured for supplementing a token sequence. Serial numbers 0-5 represent: position information of a single token in corresponding initial token sequences. As shown in FIG. 5, it can be seen that half of the tokens are used as supplementary tokens. Because these supplementary tokens also participate in the subsequent inference, a large number of redundant calculations and bandwidth overheads are caused.

In summary, in this embodiment of the present disclosure, after the N initial token sequences are acquired, a redundancy-free concatenating manner provided in operation 202 further needs to be performed to improve the inference performance.

Operation 202: Concatenate N initial token sequences into a concatenated token sequence, the concatenated token sequence being a token sequence including tokens in the N initial token sequences.

In this embodiment of the present disclosure, since the N initial token sequences do not need to be supplemented, de-dependency on length distribution of the text data can be realized. Compared with the character supplementation manner provided in the related art, GPU resources required for subsequent inference are effectively saved. In addition, the concatenated token sequence obtained in this way can be compatible with the existing deep learning framework, thereby reducing the inference cost of a plurality of pieces of text data.

In an implementation, a manner of concatenating the N initial token sequences into the concatenated token sequence may be generating a first token sequence through concatenating based on termination tokens of the N initial token sequences, and generating a second token sequence through concatenating based on tokens of the N initial token sequences except the termination tokens; and then concatenating the first token sequence at a tail of the second token sequence to obtain the concatenated token sequence.

Specifically, for the N initial token sequences, each initial token sequence is divided into two parts: a termination token located at a termination position, and other tokens located at non-termination positions. The first token sequence is obtained by concatenating N termination tokens, and the second token sequence is obtained by concatenating several other tokens.

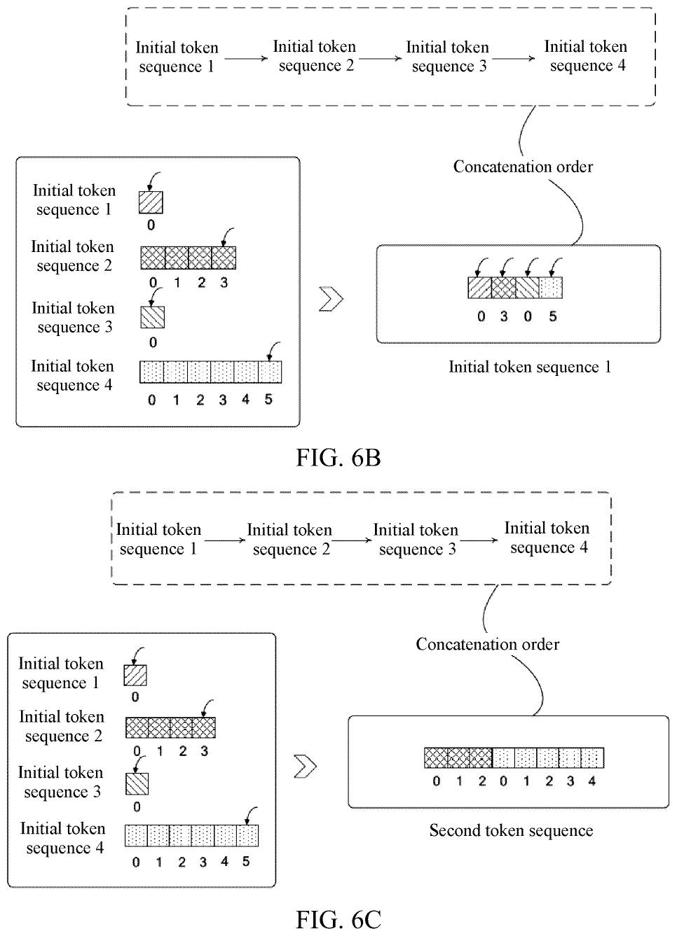

FIG. 6A is a schematic diagram of division of N initial token sequences according to an embodiment of the present disclosure. Four initial token sequences are involved. An initial token sequence 1 contains one token, an initial token sequence 2 contains four tokens, an initial token sequence 3 contains one token, and an initial token sequence 4 contains six tokens. Therefore, a token whose position information is characterized as 0 in the initial token sequence 1 is determined as a termination token 1, a token whose position information is characterized as 3 in the initial token sequence 2 is determined as a termination token 2, a token whose position information is characterized as 0 in the initial token sequence 3 is determined as a termination token 3, and a token characterized as 5 in the initial token sequence 4 is extracted as a termination token 4.

The termination token usually contains some important local information, and other tokens except the termination token may embody context information. In this embodiment of the present disclosure, abundant context information and local information may be provided for subsequent inference through such specific concatenating processing, and meanwhile, the flexibility is maintained, thereby achieving better performance in the subsequent inference tasks.

In some embodiments, the first token sequence and the second token sequence are generated through concatenating according to a preset concatenation order, and the concatenation order characterizes a processing order of the N pieces of text data.

Specifically, the determined N termination tokens are concatenated into the first token sequence based on the preset concatenation order. In addition, based on the preset concatenation order, the tokens of the N initial token sequences except the termination tokens are concatenated into the second token sequence.

FIG. 6B is a schematic diagram of obtaining a first token sequence according to an embodiment of the present disclosure. A concatenation order of an initial token sequence 1→an initial token sequence 2→an initial token sequence 3→an initial token sequence 4 is used as an example. A termination token whose position information is characterized as 0 in the initial token sequence 1, a termination token whose position information is characterized as 3 in the initial token sequence 2, a termination token whose position information is characterized as 0 in the initial token sequence 3, and a termination token whose position information is characterized as 5 in the initial token sequence 4 are sequentially concatenated to obtain the first token sequence.

Correspondingly, based on a processing order of the N pieces of text data, the tokens of the N initial token sequences except the termination tokens are sequentially concatenated to obtain a second token sequence.

FIG. 6C is a schematic diagram of obtaining a second token sequence according to an embodiment of the present disclosure. A concatenation order of an initial token sequence 1→an initial token sequence 2→an initial token sequence 3→an initial token sequence 4 is used as an example. Three tokens whose position information is characterized as 0, 1, and 2 in the initial token sequence 2 and four tokens whose position information is characterized as 0, 1, 2, 3, and 4 in the initial token sequence 4 are sequentially concatenated to obtain the second token sequence.

Concatenating is performed according to a processing order of the N pieces of text data so that when there is a relationship or dependency (such as a dialog or a story) among the N pieces of text data, the relationship may be better captured to generate reply data more accurately. For example, in a dialog system, concatenating a dialog history in a chronological order may help understand context and intentions of a dialog. The processing order of the N pieces of text data may be determined in any one of the following manners. This is not specifically limited in the present disclosure. For example, an acquisition order of the N pieces of text data is used as the processing order of the N pieces of text data. For example, a chronological order of timestamps corresponding to the N pieces of text data is used as the processing order of the N pieces of text data. For another example, an order of priorities corresponding to the N pieces of text data is used as the processing order of the N pieces of text data.

After the first token sequence and the second token sequence are acquired, referring to FIG. 6D, a schematic diagram of obtaining a concatenated token sequence according to an embodiment of the present disclosure is shown. The first token sequence is concatenated to a termination position (i.e., a tail) of the second token sequence to obtain the concatenated token sequence.

In some embodiments, as a possible implementation, in the concatenated token sequence, each token may further be associated with the following information: position information of one token in a corresponding initial token sequence, association information between one token and text data corresponding to an initial token sequence to which the token belongs, and the like.

Illustratively, for a target sequence shown in FIG. 6D, a token corresponding to a square is obtained by encoding a corresponding character, and the square itself characterizes encoding information of the corresponding character (i.e., the token). A square pattern is configured for characterizing association information between a corresponding token and text data corresponding to an initial token sequence to which the corresponding token belongs, and a value identified below the square is configured for characterizing position information of the corresponding token in the initial token sequence to which the corresponding token belongs.

In summary, the embodiments of the present disclosure provide a redundancy-free concatenating manner for the N initial token sequences. The concatenated token sequence obtained in this way may avoid dependency on length distribution of the N initial token sequences in the related art. Further, to ensure the correctness of an inference result corresponding to the concatenated token sequence, operation 203 of performing inference on the concatenated token sequence needs to be performed.

Operation 203: Perform inference on the concatenated token sequence to obtain N reply token sequences, the N reply token sequences being configured for generating reply data of the N pieces of text data, and a starting token in each reply token sequence being obtained by: performing, in the concatenated token sequence, inference on tokens belonging to the same initial token sequence.

After the concatenated token sequence is obtained, inference may be directly performed on the concatenated token sequence to obtain the N reply token sequences, thereby generating the reply data of the N pieces of text data. The reply token sequence is obtained by performing inference on tokens belonging to the same initial token sequence in the concatenated token sequence, and each reply token sequence is configured for generating corresponding reply data for replying to corresponding text data.

In this embodiment of the present disclosure, an attention mechanism may be introduced in the inference process. In this case, a manner of performing inference on the concatenated token sequence to obtain the N reply token sequences may be performing inference on the concatenated token sequence based on the attention mechanism to obtain the N reply token sequences. Tokens belonging to different initial token sequences in the concatenated token sequence are isolated through the attention mechanism to ensure the inference accuracy of the obtained N reply token sequences, thereby ensuring the accuracy of the reply data of the N pieces of text data.

An optimized inference manner for a plurality of pieces of text data is proposed, and the attention mechanism is introduced to perform inference on the concatenated token sequence to obtain the N reply token sequences. The N reply token sequences are configured for generating the reply data of the N pieces of text data. In addition, the starting token in each reply token sequence is obtained by: performing, in the concatenated token sequence, inference on the tokens belonging to the same initial token sequence. In other words, introducing the attention mechanism to the inference process is to obtain the reply data of the N pieces of text data. To obtain N pieces of accurate reply data, the starting token of each reply token sequence needs to be determined. Based on this, the N reply token sequences are obtained. In this way, the attention mechanism is introduced to the data inference process, and the tokens belonging to different initial token sequences in the concatenated token sequence are isolated to ensure the inference accuracy of the obtained N reply token sequences, thereby ensuring the accuracy of the reply data of the N pieces of text data.

According to the text data inference method provided in the embodiments of the present disclosure, in an inference scene to which the LLM is applied, the inference performance of the computer device for a specific sequence by invoking a large number of model parameters may be greatly improved. For example, for N pieces of text data with large differences in length, this solution, compared with the character supplementation manner provided in the related art, can improve the inference performance by more than doubling and ensure the correctness of the inference result based on the attention mechanism. This solution can not only adapt to the existing deep learning model framework, but also realize model framework independence to adapt to a model framework proposed later, improve the utilization of GPU resources, and reduce the inference cost of the text data. Specifically, a manner of performing inference on the concatenated token sequence based on the attention mechanism to obtain the N reply token sequences may be inputting the concatenated token sequence into a text inference model, and performing, according to the attention mechanism, inference on the tokens in the concatenated token sequence through the text inference model to output a candidate token sequence, each token in the candidate token sequence being: an inference result of one token in the concatenated token sequence; then determining, from the candidate token sequence, inference results corresponding to termination tokens of the N initial token sequences to obtain N selected tokens; and performing iterative inference on the N selected tokens based on the text inference model to obtain the N reply token sequences outputted by the text inference model, where the N selected tokens are starting tokens of the N reply token sequences.

In other words, the concatenated token sequence is inputted into the text inference model to obtain the candidate token sequence outputted by the text inference model according to the attention mechanism. Each token in the candidate token sequence is an output result of one token in the concatenated token sequence. Then, N tokens are selected from the tokens in the candidate token sequence as the N selected tokens. The N selected tokens correspond to tokens in the concatenated token sequence and are last tokens in the N initial token sequences, and a termination token (the last token) in each initial token sequence is configured for characterizing the last character in one piece of text data. Then, the N selected tokens are used as first tokens in the N reply token sequences and inputted into the text inference model to obtain other tokens in the N reply token sequences. The N reply token sequences herein are configured for generating the reply data of the N pieces of text data.

For ease of understanding, the inference process for the concatenated token sequence in this embodiment of the present disclosure is described in detail below with reference to a universal deep learning model framework.

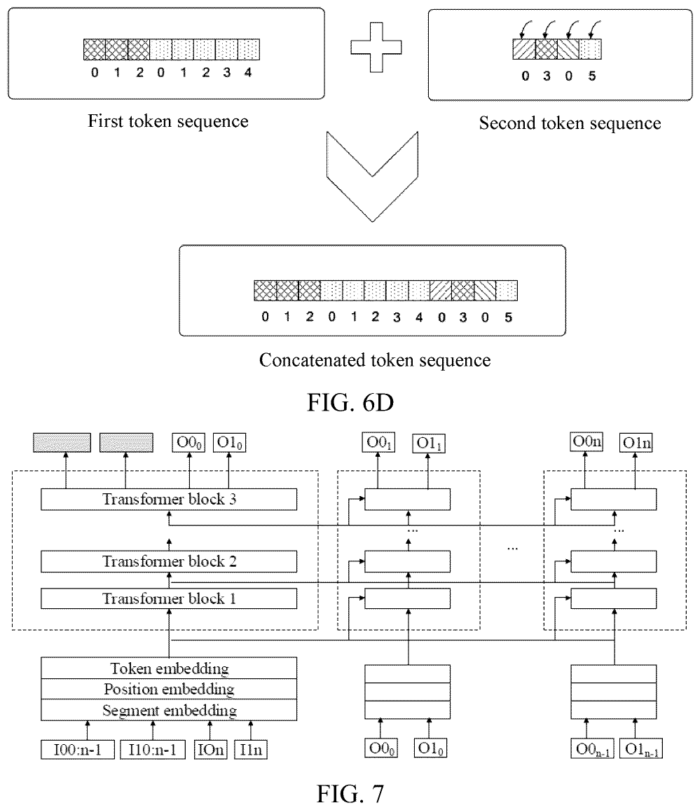

FIG. 7 is a schematic diagram of a process of performing inference on a concatenated token sequence based on a deep learning model framework according to an embodiment of the present disclosure. Herein, a concatenated token sequence obtained by concatenating two initial token sequences I00: n−1 and I10: n−1 is used as an example. For ease of understanding, as shown in FIG. 7, the concatenated token sequence is shown as two corresponding initial token sequences. A person skilled in the art will know that performing inference on the tokens in the concatenated token sequence by the computer device is essentially performing inference on tokens in the two initial token sequences.

As shown in FIG. 7, it can be seen that two initial token sequences I00: n−1 and I10: n−1 (i.e., the concatenated token sequence) are inputted into the text inference model. O00 and O10 are inference tokens corresponding to termination tokens of I00: n−1 and I10: n−1 after the model performs inference on the tokens in I00: n−1 and I10: n−1 (i.e., tokens in the concatenated token sequence). A first O of each of O00 and O10 represents a model output, a second 0 of O00 represents a corresponding first initial token sequence, a second 1 of O10 represents a corresponding second initial token sequence, and a third 0 of each of O00 and O10 represents an inference token outputted after inference is performed on a termination token in the corresponding token sequence. Therefore, O00 and O10 also represent first tokens of reply token sequences of the text data corresponding to the two initial token sequences. Then, O00 and O10 are inputted into the text inference model to generate inference tokens corresponding to the two inputs, and this operation is repeated until reply token sequences corresponding to the two pieces of text data are generated. One reply token sequence may be: a concatenation sequence of O00, O01, . . . , and O0n. The other reply token sequence may be: a concatenation sequence of O10, O11, . . . , and O1n.

That is, in the inference process for the concatenated token sequence, this embodiment of the present disclosure is mainly based on the attention mechanism so that in the data inference process performed by the text inference model, it is ensured that each outputted inference token performs association inference only with an input token and a generated inference token corresponding to the outputted inference token, thereby realizing inference isolation on different pieces of text data in the inference process of the concatenated token sequence.

An application form of the attention mechanism in the inference process may be an attention matrix, and certainly may alternatively be another form. This is not specifically limited herein. In this solution, a preset attention matrix is used as an example, and details are not described below again.

The preset attention matrix characterizes: in the inference process, based on the association relationship between the tokens in the concatenated token sequence and the initial token sequences to which the tokens belong, degrees of attention to the tokens and the inference tokens corresponding to the tokens. The attention matrix may contain several rows of elements, and the several rows of elements characterize: different degrees of attention to the tokens in the concatenated token sequence in an inference process. Alternatively, the several rows of elements characterize: different degrees of attention to the elements in the concatenated token sequence and inference tokens corresponding to the elements in the inference process.

As an example, the attention matrix contains: Q+P×N rows of elements. Q is a total number of tokens in the concatenated token sequence, and the Q rows of elements characterize: different degrees of attention to the tokens in the concatenated token sequence in the inference process, where P is a positive integer. Elements in P×N rows of elements characterize different degrees of attention to the tokens in the concatenated token sequence and inference tokens corresponding to the tokens in the inference process. Each N rows of elements correspond to N pieces of text data.

For ease of understanding, an attention matrix corresponding to a single initial token sequence is first used as an example below to briefly describe a composition structure of the attention matrix provided in this embodiment of the present disclosure.

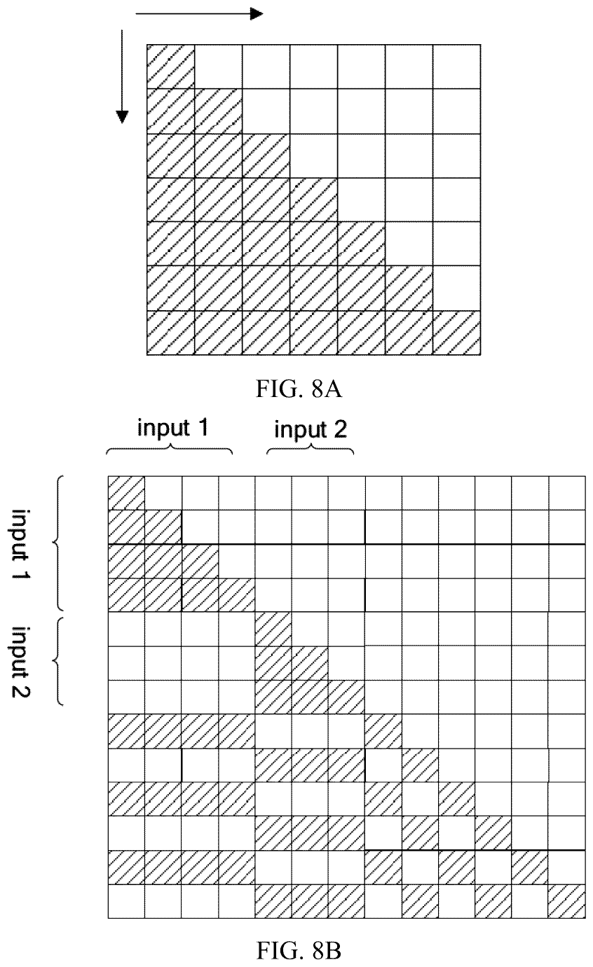

FIG. 8A shows the attention matrix corresponding to a single initial token sequence. A column number and a row number in the attention matrix may represent serial numbers of tokens. From the top to the bottom, only a first one in a first row is padded with slash bars, which represents that a first token in the single initial token sequence can only perform inference based on the attention mechanism with itself. Only a first one and a second one in a second row are padded with slash bars, which represents that a second token in the single initial token sequence may perform inference based on the attention mechanism with itself and the first token. The rest may be deduced by analogy. In other words, the attention matrix shown in FIG. 8A represents that each token in the single initial token sequence can only perform inference based on the attention mechanism with itself (the token itself may alternatively be an inference token here) and its previous tokens.

After the attention matrix corresponding to the single initial token sequence is described, an attention matrix corresponding to the concatenated token sequence provided in this embodiment of the present disclosure is described in detail below.

For Q+P×N rows of elements in the foregoing attention matrix, an arrangement order of Q rows of elements is determined based on a token arrangement order of tokens included in the N initial token sequences except the termination tokens. The Q rows of elements may be determined in the following manner: a starting token (a non-termination token) in any initial token sequence is selected and used as an attention token in the inference process, position information of the starting token in the concatenated token sequence is determined to construct a first row of elements, and then similar operations are performed according to subsequent tokens (non-termination tokens) in the same initial token to generate corresponding rows of elements. The rest may be deduced by analogy, and the Q rows of elements are generated.

In a possible implementation, a manner of performing, according to the attention mechanism, inference on the tokens in the concatenated token sequence through the text inference model to output the candidate token sequence may be: acquiring Q rows of elements in a preset attention matrix, then performing, based on the Q rows of elements, inference on the tokens belonging to the same initial token sequence in the concatenated token sequence to obtain inference tokens corresponding to the tokens in the concatenated token sequence, and obtaining the candidate token sequence generated by concatenating the inference tokens.

For Q+P×N rows of elements in the foregoing attention matrix, an arrangement order of P×N rows of elements is determined based on a processing order of the N pieces of text data. That is, the arrangement order is consistent with a generation order of the N reply token sequences.

In a possible implementation, a manner of performing iterative inference on the N selected tokens based on the text inference model to obtain the N reply token sequences outputted by the text inference model may be: using the N selected tokens as the starting tokens of the N reply token sequences; acquiring P×N rows of elements in the preset attention matrix, and then sequentially performing P operations on each N rows of elements of the P×N rows of elements to obtain the N reply token sequences. One operation is specifically performed as follows:
performing, based on the N rows of elements, inference on currently obtained N selected tokens to obtain N inference tokens, where the N rows of elements characterize: different degrees of attention to the currently obtained N selected tokens in an inference process; and then concatenating the N inference tokens to tails of the N reply token sequences, and using the N inference tokens as N selected tokens obtained next time.

In the following, a relatively complete example is adopted to exemplarily describe the inference process in which the text inference model performs inference on the concatenated token sequence based on the attention matrix to obtain the N reply token sequences.

FIG. 8B shows an attention matrix preset for a concatenated token sequence. The concatenated token sequence is obtained by concatenating a first initial token sequence containing five tokens and a second initial token sequence containing four tokens. The obtaining manner through concatenating may refer to the related description of operation 202. Details are not described herein again.

As shown in FIG. 8B, input1 includes four rows of elements that correspond to first four tokens in the first initial token sequence included in the concatenated token sequence, and input2 includes three rows of elements that represent first three tokens in the second initial token sequence included in the concatenated token sequence. In this case, input1+input2 includes 7 (i.e., Q) rows of elements, and the candidate token sequence corresponding to the concatenated token sequence may be obtained through inference based on the 7 rows of elements. An eighth row represents a termination token in the first initial token sequence included in the concatenated token sequence. That is, the termination token in the first initial token sequence only performs attention mechanism-based inference with the first four tokens in the first initial token sequence. A ninth row represents a termination token in the second initial token sequence included in the concatenated token sequence. That is, the termination token in the second initial token sequence only performs attention mechanism-based inference with the first three tokens in the second initial token sequence. Then, the eighth row and the ninth row of elements constitute N rows of elements, and the attention matrix may be expanded to P×N rows of elements subsequently according to an output length of the text inference model.

The foregoing self-expansion of the attention matrix is related to a generation order of inference results of the N pieces of text data. Therefore, the self-expansion of the attention matrix generally needs to be performed by following a preset concatenation order.

The following provides an overall description of a multi-text data inference method provided in the embodiments of the present disclosure with reference to an actual application scene. A dialog scene in which the LLM is applied is used as an example.

Various questions or to-be-inferred dialog data inputted by the user object in a display interface are used as to-be-processed text data. After acquiring a piece of to-be-processed text data inputted by the user object, the computer device does not directly enable the LLM, but prepares to enable the LLM after receiving N (N being an integer greater than 1) pieces of text data, to perform inference on the N pieces of text data.

Subsequently, for N pieces of to-be-processed text data, the computer device encodes characters in the text data to obtain corresponding initial token sequences. Then, N initial token sequences are divided into termination tokens and non-termination tokens. Based on a preset concatenation order, the first token sequence obtained by concatenating N termination tokens is concatenated to the tail of the second token sequence obtained by concatenating several non-termination tokens, to obtain the concatenated token sequence. The concatenated token sequence contains all tokens in the N initial token sequences.

Then, the concatenated token sequence is inputted into the LLM to obtain the candidate token sequence outputted by the LLM through inference on the tokens in the concatenated token sequence according to the attention mechanism. Each token in the candidate token sequence is: an inference result of one token in the concatenated token sequence. Then, inference results corresponding to the termination tokens of the N initial token sequences are determined from the candidate token sequence to obtain N selected tokens. Subsequently, iterative inference is performed on the N selected tokens based on the text inference model to obtain the N reply token sequences outputted by the text inference model. The N selected tokens are starting tokens of the N reply token sequences.

In summary, the embodiments of the present disclosure provide a multi-text data inference method, which may greatly improve the inference performance of the LLM, especially for an LLM of a transformer type. In a scene in which a plurality of pieces of text data have large differences in length, this solution, compared with an existing method for supplementing text data, may improve the inference performance by more than doubling, thereby alleviating the problem of excessively high inference costs of the current LLM to some extent. In addition, compared with an optimization solution of a deep learning model framework provided in the related art, this solution not only has no dependency on the distribution of a plurality of text data, thereby improving the inference performance, but also may be compatible with the existing deep learning model framework (such as Huggingface, Pytorch, and Tensorflow), thereby improving the inference flexibility for the plurality of text data.

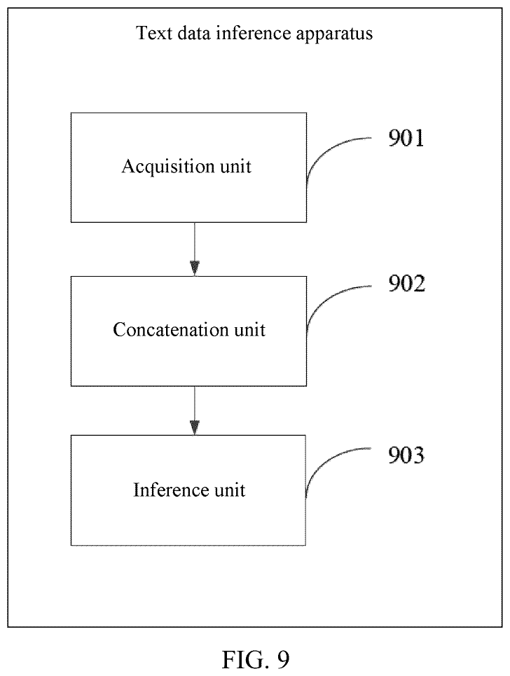

Referring to FIG. 9, based on the same inventive concept, the embodiments of the present disclosure further provide a text data inference apparatus, including:

an acquisition unit 901 configured to acquire initial token sequences corresponding to N pieces of text data, N being an integer greater than 1, and one token in each initial token sequence characterizing one character in corresponding text data;

a concatenation unit 902 configured to concatenate N initial token sequences into a concatenated token sequence, the concatenated token sequence being a token sequence including tokens in the N initial token sequences; and

an inference unit 903 configured to perform inference on the concatenated token sequence to obtain N reply token sequences, the N reply token sequences being configured for generating reply data of the N pieces of text data, and a starting token in each reply token sequence being obtained by: performing, in the concatenated token sequence, inference on tokens belonging to the same initial token sequence.

In some embodiments, the inference unit 903 is specifically configured to:
perform inference on the concatenated token sequence based on an attention mechanism to obtain the N reply token sequences.

In some embodiments, the inference unit 903 is specifically configured to:
input the concatenated token sequence into a text inference model, and perform, according to the attention mechanism, inference on the tokens in the concatenated token sequence through the text inference model to output a candidate token sequence, each token in the candidate token sequence being: an inference result of one token in the concatenated token sequence;
determine, from the candidate token sequence, inference results corresponding
to termination tokens of the N initial token sequences to obtain N selected tokens; and
perform iterative inference on the N selected tokens based on the text inference model to obtain the N reply token sequences outputted by the text inference model, where the N selected tokens are starting tokens of the N reply token sequences.

In some embodiments, the inference unit 903 is configured to:
acquire Q rows of elements in a preset attention matrix, where Q is a total number of tokens in the concatenated token sequence, and the Q rows of elements characterize: different degrees of attention to the tokens in the concatenated token sequence in an inference process;
perform, based on the Q rows of elements, inference on the tokens belonging
to the same initial token sequence in the concatenated token sequence to obtain inference tokens corresponding to the tokens in the concatenated token sequence; and
obtain the candidate token sequence generated by concatenating the inference tokens.

In some embodiments, the inference unit 903 is configured to:
use the N selected tokens as the starting tokens of the N reply token sequences;
acquire P×N rows of elements in the preset attention matrix, P being a positive integer; and
sequentially perform the following operations on each N rows of elements of the P×N rows of elements:
performing, based on the N rows of elements, inference on currently obtained N selected tokens to obtain N inference tokens, where the N rows of elements characterize: different degrees of attention to the currently obtained N selected tokens in an inference process;
concatenating the N inference tokens to tails of the N reply token sequences, and using the N inference tokens as N selected tokens obtained next time; and
obtaining the N reply token sequences until P operations are performed.

In some embodiments, the acquisition unit 901 is specifically configured to:
acquire N pieces of to-be-replied text data; and
encode, for each of the N pieces of text data, characters in the text data into corresponding tokens to obtain an initial token sequence corresponding to the text data.

In some embodiments, the concatenation unit 902 is specifically configured to:
generate a first token sequence through concatenating based on the termination tokens of the N initial token sequences;
generate a second token sequence through concatenating based on tokens of the N initial token sequences except the termination tokens; and
concatenate the first token sequence at a tail of the second token sequence to obtain the concatenated token sequence.

In some embodiments, the first token sequence and the second token sequence are generated through concatenating according to a preset concatenation order, and the concatenation order characterizes: a processing order of the N pieces of text data.

The concatenation unit 902 configured to generate a first token sequence through concatenating based on the termination tokens of the N initial token sequences is specifically configured to:
sequentially concatenate, based on the processing order of the N pieces of text data, the termination tokens of the N initial token sequences to obtain the first token sequence.

The concatenation unit 902 configured to generate a second token sequence through concatenating based on tokens of the N initial token sequences except the termination tokens is specifically configured to:
sequentially concatenate, based on the processing order of the N pieces of text data, the tokens of the N initial token sequences except the termination tokens to obtain the second token sequence.

In some embodiments, the processing order of the N pieces of text data is determined in any one of the following manners, and the concatenation unit 902 is further configured to:
use an acquisition order of the N pieces of text data as the processing order of the N pieces of text data;
use a chronological order of timestamps corresponding to the N pieces of text data as the processing order of the N pieces of text data; and
use an order of priorities corresponding to the N pieces of text data as the processing order of the N pieces of text data.

Based on the foregoing apparatus, initial token sequences corresponding to N (N being an integer greater than 1) pieces of to-be-processed text data are concatenated to obtain the concatenated token sequence, and then inference is performed on the concatenated token sequence based on the attention mechanism to obtain N reply token sequences configured for generating corresponding reply data, to reduce GPU resources consumed by the inference of the plurality of pieces of text data and improve the inference performance of the computer device on the plurality of pieces of text data.

The apparatus may be configured to perform the method shown in the embodiments of the present disclosure. Therefore, functions and the like that can be implemented by the functional modules of the apparatus may refer to the descriptions in the foregoing embodiments, and details are not described herein again.

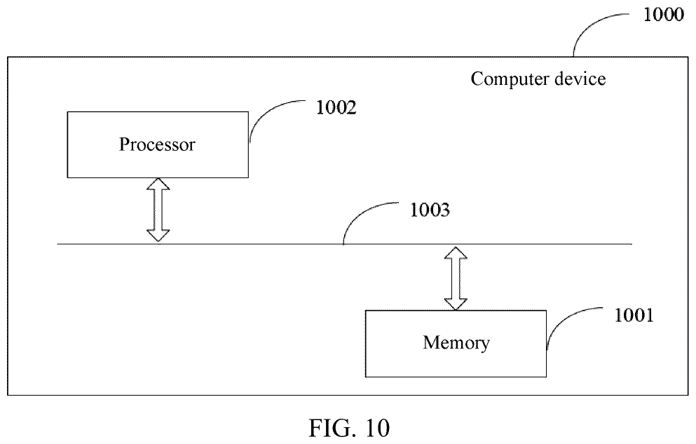

Referring to FIG. 10, based on the same technical concept, the embodiments of the present disclosure further provide a computer device 1000. The computer device 1000 may be the terminal device or the server shown in FIG. 1. The computer device 1000 may include a memory 1001 and a processor 1002.

The memory 1001 is configured to store a computer program executed by the processor 1002. The memory 1001 may mainly include a program storage area and a data storage area. The program storage area may store an operating system, an application program required by at least one function, and the like. The data storage area may store data created based on the use of the computer device, and the like. The processor 1002 may be a central processing unit (CPU), a digital processing unit, or the like. A specific connection medium between the memory 1001 and the processor 1002 is not limited in this embodiment of the present disclosure. In this embodiment of the present disclosure, the memory 1001 and the processor 1002 are connected through a bus 1003 in FIG. 10. The bus 1003 is represented through a thick line in FIG. 10. A connection manner between other components is merely for exemplary description and is not intended to be limiting. The bus 1003 may be classified as an address bus, a data bus, a control bus, or the like. For ease of representation, only one thick line is adopted to represent the bus in FIG. 10, but this does not indicate that there is only one bus or only one type of bus.

The memory 1001 may be a volatile memory, for example, a random-access memory (RAM). The memory 1001 may alternatively be a non-volatile memory, for example, a read-only memory (ROM), a flash memory, a hard disk drive (HDD), or a solid-state drive (SSD). Alternatively, the memory 1001 is any other medium that can be configured to carry or store a desired computer program in a form of an instruction or a data structure and can be accessed by a computer, but is not limited thereto. The memory 1001 may be a combination of the foregoing memories.

The processor 1002 is configured to perform the method performed by the device in the embodiments of the present disclosure when invoking the computer program stored in the memory 1001.

In some possible implementations, various aspects of the method provided in the present disclosure may further be implemented in the form of a computer program product, which includes a computer program. When the program product runs on the computer device, the computer program is configured for causing the computer device to perform operations in the method according to various exemplary implementations of the present disclosure described above in this specification. For example, the computer device may perform the method performed by the device in the embodiments of the present disclosure.

The computer program product may use any combination of one or more readable media. The readable medium may be a readable signal medium or a readable storage medium. For example, the readable storage medium may be, but is not limited to, an electric, magnetic, optical, electromagnetic, infrared, or semi-conductive system, apparatus, or device, or any combination thereof. More specific examples (a non-exhaustive list) of the readable storage medium include: an electrical connection having one or more wires, a portable disk, a hard disk, a RAM, a ROM, an erasable programmable ROM (EPROM or a flash memory), an optical fiber, a portable compact disc ROM (CD-ROM), an optical storage device, a magnetic storage device, or any appropriate combination thereof.

Although exemplary embodiments of the present disclosure have been described, once a person skilled in the art knows the basic creative concept, additional changes and modifications may be made to these embodiments. Therefore, the following claims are intended to be construed as to include the exemplary embodiments and all changes and modifications falling within the scope of the present disclosure.

Obviously, a person skilled in the art may make various modifications and variations to the present disclosure without departing from the spirit and scope of the present disclosure. In this case, if the modifications and variations made to the present disclosure fall within the scope of the claims of the present disclosure and their equivalent technologies, the present disclosure is intended to contain these modifications and variations.

What is claimed is:

1. A text data inference method, comprising:
acquiring N initial token sequences corresponding to N pieces of text data, wherein Nis an integer greater than 1 and one token in each initial token sequence characterizes one character in corresponding text data;
concatenating N initial token sequences into a concatenated token sequence, the concatenated token sequence being a token sequence comprising tokens in the N initial token sequences; and
performing inference on the concatenated token sequence for obtaining N reply token sequences, wherein the N reply token sequences are configured for generating reply data of the N pieces of text data and a starting token in each reply token sequence is obtained by performing, in the concatenated token sequence, inference on tokens belonging to the same initial token sequence.

2. The method according to claim 1, wherein performing the inference on the concatenated token sequence for obtaining N reply token sequences comprises:
performing the inference on the concatenated token sequence based on an attention mechanism to obtain the N reply token sequences.

3. The method according to claim 2, wherein performing the inference on the concatenated token sequence based on the attention mechanism to obtain the N reply token sequences comprises:
inputting the concatenated token sequence into a text inference model;
performing, according to the attention mechanism, the inference on the tokens in the concatenated token sequence through the text inference model to output a candidate token sequence, wherein each token in the candidate token sequence is an inference result of one token in the concatenated token sequence;
determining, from the candidate token sequence, inference results corresponding to termination tokens of the N initial token sequences to obtain N selected tokens; and
performing iterative inference on the N selected tokens based on the text inference model to obtain the N reply token sequences outputted by the text inference model, wherein the N selected tokens are starting tokens of the N reply token sequences.

4. The method according to claim 3, wherein performing, according to the attention mechanism, the inference on the tokens in the concatenated token sequence through the text inference model to output a candidate token sequence comprises:
acquiring Q rows of elements in a preset attention matrix, wherein Q is a total number of tokens in the concatenated token sequence and the Q rows of elements characterize different degrees of attention to the tokens in the concatenated token sequence in an inference process;
performing, based on the Q rows of elements, inference on the tokens belonging to the same initial token sequence in the concatenated token sequence for obtaining inference tokens corresponding to the tokens in the concatenated token sequence; and
obtaining the candidate token sequence generated by concatenating the inference tokens.

5. The method according to claim 4, further comprising:
using the N selected tokens as the starting tokens of the N reply token sequences;
acquiring P×N rows of elements in the preset attention matrix, wherein P is a positive integer; and
sequentially performing operations on each N rows of elements of the P×N rows of elements, wherein the operations comprise:
performing, based on the N rows of elements, inference on N selected tokens to obtain N inference tokens, wherein the N rows of elements characterize different degrees of attention to the N selected tokens in an inference process;
concatenating the N inference tokens to tails of the N reply token sequences;
using the N inference tokens as N selected tokens as the starting tokens of N reply token sequences next time; and
obtaining the N reply token sequences until P operations are performed.

6. The method according to claim 1, wherein acquiring N initial token sequences corresponding to N pieces of text data comprises:
acquiring the N pieces of text data; and
encoding, for each of the N pieces of text data, characters in the text data into corresponding tokens to obtain an initial token sequence corresponding to the text data.

7. The method according to claim 3, wherein concatenating the N initial token sequences into a concatenated token sequence comprises:
generating a first token sequence through concatenation based on the termination tokens of the N initial token sequences;
generating a second token sequence through concatenation based on tokens of the N initial token sequences except the termination tokens; and
concatenating the first token sequence at a tail of the second token sequence to obtain the concatenated token sequence.

8. The method according to claim 7, wherein the first token sequence and the second token sequence are generated through concatenation according to a preset concatenation order, wherein the concatenation order characterizes a processing order of the N pieces of text data; and
generating the first token sequence through concatenation based on the termination tokens of the N initial token sequences comprises:
sequentially concatenating, based on the processing order of the N pieces of text data, the termination tokens of the N initial token sequences for obtaining the first token sequence; and
generating the second token sequence through concatenation based on tokens of the N initial token sequences except the termination tokens comprises:
sequentially concatenating, based on the processing order of the N pieces of text data, the tokens of the N initial token sequences except the termination tokens for obtaining the second token sequence.

9. The method according to claim 8, wherein the processing order of the N pieces of text data is determined in at least one of the following manners:
using an acquisition order of the N pieces of text data as the processing order of the N pieces of text data;
using a chronological order of timestamps corresponding to the N pieces of text data as the processing order of the N pieces of text data; or
using an order of priorities corresponding to the N pieces of text data as the processing order of the N pieces of text data.

10. A text data inference apparatus, comprising a memory for storing instructions and a processor for executing the instructions, wherein the processor is configured to:
acquire N initial token sequences corresponding to N pieces of text data, wherein Nis an integer greater than 1 and one token in each initial token sequence characterizes one character in corresponding text data;
concatenate N initial token sequences into a concatenated token sequence, the concatenated token sequence being a token sequence comprising tokens in the N initial token sequences; and
perform inference on the concatenated token sequence for obtaining N reply token sequences, wherein the N reply token sequences are configured for generating reply data of the N pieces of text data and a starting token in each reply token sequence is obtained by performing, in the concatenated token sequence, inference on tokens belonging to the same initial token sequence.

11. The text data inference apparatus of claim 10, wherein the processor, when being configured to perform the inference on the concatenated token sequence for obtaining N reply token sequences, is configured to:
perform the inference on the concatenated token sequence based on an attention mechanism to obtain the N reply token sequences.

12. The text data inference apparatus of claim 11, wherein the processor, when being configured to perform the inference on the concatenated token sequence based on the attention mechanism to obtain the N reply token sequences, is configured to:
input the concatenated token sequence into a text inference model;
perform, according to the attention mechanism, the inference on the tokens in the concatenated token sequence through the text inference model to output a candidate token sequence, wherein each token in the candidate token sequence is an inference result of one token in the concatenated token sequence;
determine, from the candidate token sequence, inference results corresponding to termination tokens of the N initial token sequences to obtain N selected tokens; and
perform iterative inference on the N selected tokens based on the text inference model to obtain the N reply token sequences outputted by the text inference model, wherein the N selected tokens are starting tokens of the N reply token sequences.

13. The text data inference apparatus of claim 12, wherein the processor, when being configured to perform, according to the attention mechanism, the inference on the tokens in the concatenated token sequence through the text inference model to output a candidate token sequence, is further configured to:
acquire Q rows of elements in a preset attention matrix, wherein Q is a total number of tokens in the concatenated token sequence and the Q rows of elements characterize different degrees of attention to the tokens in the concatenated token sequence in an inference process;
perform, based on the Q rows of elements, inference on the tokens belonging to the same initial token sequence in the concatenated token sequence for obtaining inference tokens corresponding to the tokens in the concatenated token sequence; and
obtain the candidate token sequence generated by concatenating the inference tokens.

14. The text data inference apparatus of claim 13, comprising a memory for storing instructions and a processor for executing the instructions, wherein the processor is further configured to:
use the N selected tokens as the starting tokens of the N reply token sequences;
acquire P×N rows of elements in the preset attention matrix, wherein P is a positive integer; and
sequentially perform operations on each N rows of elements of the P×N rows of elements, wherein the operations comprise:
performing, based on the N rows of elements, inference on N selected tokens to obtain N inference tokens, wherein the N rows of elements characterize different degrees of attention to the N selected tokens in an inference process;
concatenating the N inference tokens to tails of the N reply token sequences;
using the N inference tokens as N selected tokens as the starting tokens of N reply token sequences next time; and
obtaining the N reply token sequences until P operations are performed.

15. The text data inference apparatus of claim 10, comprising a memory for storing instructions and a processor for executing the instructions, wherein the processor, being configured to acquire N initial token sequences corresponding to N pieces of text data, is further configured to:
Acquire the N pieces of text data; and
encode, for each of the N pieces of text data, characters in the text data into corresponding tokens to obtain an initial token sequence corresponding to the text data.

16. The text data inference apparatus of claim 12, wherein the processor, when being configured to concatenate the N initial token sequences into a concatenated token sequence, is further configured to:
generate a first token sequence through concatenation based on the termination tokens of the N initial token sequences;
generate a second token sequence through concatenation based on tokens of the N initial token sequences except the termination tokens; and
concatenate the first token sequence at a tail of the second token sequence to obtain the concatenated token sequence.

17. The text data inference apparatus of claim 16, wherein the first token sequence and the second token sequence are generated through concatenation according to a preset concatenation order, wherein the concatenation order characterizes a processing order of the N pieces of text data; and
wherein the processor, being configured to generate the first token sequence through concatenation based on the termination tokens of the N initial token sequences, is further configured to:
sequentially concatenate, based on the processing order of the N pieces of text data, the termination tokens of the N initial token sequences for obtaining the first token sequence; and
wherein the processor, being configured to generate the second token sequence through concatenation based on tokens of the N initial token sequences except the termination tokens, is further configured to:
sequentially concatenate, based on the processing order of the N pieces of text data, the tokens of the N initial token sequences except the termination tokens for obtaining the second token sequence.

18. The text data inference apparatus of claim 17, wherein the processing order of the N pieces of text data is determined in at least one of the following manners:
using an acquisition order of the N pieces of text data as the processing order of the N pieces of text data;
using a chronological order of timestamps corresponding to the N pieces of text data as the processing order of the N pieces of text data; or
using an order of priorities corresponding to the N pieces of text data as the processing order of the N pieces of text data.

19. A non-transitory computer readable medium storing a plurality of instructions, wherein the plurality of instructions, when executed by a processor, configure the processor to:
acquire N initial token sequences corresponding to N pieces of text data, wherein Nis an integer greater than 1 and one token in each initial token sequence characterizes one character in corresponding text data;
concatenate N initial token sequences into a concatenated token sequence, the concatenated token sequence being a token sequence comprising tokens in the N initial token sequences; and
perform inference on the concatenated token sequence for obtaining N reply token sequences, wherein the N reply token sequences are configured for generating reply data of the N pieces of text data and a starting token in each reply token sequence is obtained by performing, in the concatenated token sequence, inference on tokens belonging to the same initial token sequence.

20. The non-transitory computer readable medium storing a plurality of instructions of claim 19, wherein the plurality of instructions, when executed by a processor, configure the processor to perform inference on the concatenated token sequence for obtaining N reply token sequences, further configure the processor to:
perform inference on the concatenated token sequence based on an attention mechanism to obtain the N reply token sequences.
